(19) United States
(12) Patent Application Publication
(10) Pub. No.: US 2011/0302097 A1
(43) Pub. Date: Dec. 8, 2011

(54) BEHAVIOR-BASED NETWORKS

(75) Inventors: Chinmay Lonkar, Kirkland, WA (US); Jennifer P. Roth, Philadelphia, PA (US); Bo J. Rohlfsen, Seattle, WA (US); Jeffrey John McKean, Renton, WA (US); Eric Christian Berridge, Renton, WA (US); David Alles, Seattle, WA (US)

(73) Assignee: Microsoft Corporation, Redmond, WA (US)

(21) Appl. No.: 12/793,800

(22) Filed: Jun. 4, 2010

(51) Int. Cl. G06N 5/02; G06Q 99/00

(52) U.S. Cl. 705/319; 706/54

(57) ABSTRACT

A networking service that receives information about behaviors of the users, such as behaviors in which a user is engaging now or will engage in the future. The networking service compares the behavior information to identify matches between two or more users. When a match is detected, the networking service may form a network (e.g., a social network) between the two or more users by connecting the users in a network. The users may then communicate in the network, and additional users may be added to the network when those users are determined to be engaging in the behavior. When the networking service detects that the users are no longer engaging in the behaviors on which the match was identified, the networking service may disconnect users from one another or the network, and the networking service may eliminate the network.

### BACKGROUND

Networking, when used in the context of interpersonal relationships, refers to the creation and maintenance of such interpersonal relationships. For example, networking may be used to create/maintain friendships, romantic relationships, business relationships, and other types of relationships.

Services have been created to aid in networking by allowing people to search for and communicate with one another so as to create new relationships or maintain existing relationships. Users of these services can identify other users of the system with which they have a relationship and the users may then communicate. Additionally, once users have identified one another, the users may also establish a link between each other using the system, such that the users may find each other more readily in the future or so that information may be shared more readily.

One way that users with existing relationships can identify each other using these service is by explicitly searching for other users having particular characteristics. To do so, one user could search for another by name, college, hometown, or other identifying characteristics. Another way that users can identify each other is through recommendations provided by the services. The services may detect that some identifying information that has been explicitly input by the users (e.g., college, hometown) indicates a match between the users and the services may call attention to that match to encourage the users to identify one another.

### SUMMARY

While existing networking services permit users with existing relationships to identify one another and communicate, existing services do not readily permit users that do not have existing relationships to identify one another. Where the services suggest a match with another user, these services make recommendations based only on whether the user is likely to have an existing relationship with the other user.

Some users of a networking service may wish to identify and communicate with other users with which they do not have an existing relationship. For example, a user may wish to identify others an experience with the user, such that the user may take part in the experience with those users. For example, if a user is at a concert, the user may wish to connect to and communicate with other users at the concert, to share the concert experience with the other users of the networking service.

In one embodiment, a networking service will permit users to opt-in to a behavioral monitoring and matching system. For those users that opt-in, the networking service will receive information about behaviors of the users, such as behaviors in which a user is engaging now or will engage in the future. The networking service compares the behavior information to identify matches between two or more users. When a match is detected, the networking service may form a network between the two or more users by connecting the users in a network. The users may then communicate in the network, and additional users may be added to the network when those users are determined to be engaging in the behavior. When the networking service detects that the users are no longer engaging in the behaviors on which the match was identified, the networking service may disconnect users from one another or the network, and the networking service may eliminate the network.

In this embodiment, the networking service may make determinations about whether to connect two users in a network based on a detected match between behaviors using a calculated match value. Two users may be connected when at least one property of behaviors engaged in by the users matches, such as a location of the behavior of the users. Each behavior property on which the networking service may establish a network may have a corresponding weighting factor, and the networking service may calculate a match value based at least in part on the weighting factors of the behavior properties detected to be matches. When a match value calculated for one or more behavior properties exceeds a threshold, a network may be established based on those behavior properties. Additional users that also match those behavior properties may then be added to the network.

The foregoing is a non-limiting summary of embodiments of the invention, which is defined by the attached claims.

### BRIEF DESCRIPTION OF DRAWINGS

The accompanying drawings are not intended to be drawn to scale. In the drawings, each identical or nearly identical component that is illustrated in various figures is represented by a like numeral. For purposes of clarity, not every component may be labeled in every drawing. In the drawings:

FIG. 1 is a flowchart of one process that may be implemented for joining users in behavior-based networks;

FIG. 2 is a flowchart of one process that may be implemented for joining a user to an existing behavior-based network;

FIG. 3 is a flowchart of one process that may be implemented for disconnecting a user from a behavior-based network to which the user is connected;

FIG. 4 is a flowchart of one process that may be implemented for eliminating a behavior-based network from a networking service;

FIG. 5 is a flowchart of one process that may be implemented for receiving, at a networking service, information about a behavior of a user;

FIG. 6 is a flowchart of one process that may be implemented for comparing behavior properties relating to a behavior of a user by evaluating a similarity of properties;

FIG. 7 is a flowchart of one process that may be implemented for comparing behavior properties relating to a behavior of a user by applying weighting factors to behavior properties;

FIG. 8 is a flowchart of one process that may be implemented for adjusting weighting factors and similarity calculations based on conditions of a networking service;

FIG. 9 is a flowchart of one process that may be implemented for adjusting weighting factors and similarity calculations based on a user's interactions with a networking service;

FIG. 10 is a flowchart of one process for managing behavior-based networks when weighting factors and similarity calculations are adjusted based on conditions of a networking service;

FIG. 11 illustrates one exemplary computer system in which embodiments may operate; and

FIG. 12 is a block diagram of a computing device with which some embodiments may operate.

### DETAILED DESCRIPTION

Networking services, as discussed above, permit users to identify and communicate with one another. For example, users may connect to one another in a “network” of users. The users that are connected may then communicate, using the networking service, directly between one another, may communicate with all users in the network, or may communicate in any other suitable manner.

When people experience something, such as when they are engaging in a behavior, they typically like to share that experience with others. For example, while at a concert or athletic event, they may like to discuss the event with others at the event. Networking services could be useful to allow users to discuss their experiences with others. Conventional networking services, however, operate to connect users with existing relationships outside of the networking service. Conventional networking services do not permit users to establish relationships with other users that are sharing an experience, such as engaging in similar behavior. Thus, conventional networking services are not useful to people that experience something and would like to communicate with other people who share the experience.

Described herein are techniques for permitting users of a networking service to identify, connect to, and communicate with one another when the users are engaged or will engage in a same offline behavior. Offline behavior, as used herein, may be any behavior in which a user may engage outside of the networking service. Examples of offline experiences include being at a location, being at an event (e.g., concert or sporting event), experiencing media (e.g., listening to a particular band's music, watching a television show), using a particular electronic device, and many others. Users may be engaged in a same offline behavior when the users' offline behaviors are identical or are similar in at least one way.

In some embodiments, as discussed further below, a comparison of user behavior may be carried out by comparing behavior properties for user behaviors. Behavior properties may be any information that describes a behavior of a user, including what the behavior is, where or when the user is engaging in the behavior, who the user is engaging in the behavior with, why the user is engaging in the behavior, or any other properties. A behavior may be described by one or more behavior properties. Behavior properties may be received from a user or computing device or may be derived from information received about a behavior received from a user or computing device.

Any suitable networking service may be used with techniques implemented herein. One type of networking service with which embodiments may operate is a social networking service. In such a networking service, users will be able to communicate with one another using the networking service. For example, users may be able to communicate messages directly to one another. As another example, users may be able to communicate messages to groups of users, such as using a web-based bulletin board or other communication technique. Such communications to groups of users may be made to users that are connected in a network. As used herein, a network of a networking service is a collection of two or more users that are connected to one another.

In conventional networking services, a network may be formed of users that have a pre-existing offline connection. Such a network is based on those pre-existing offline relationships. In accordance with techniques described herein, some networks may be based on a similar behavior in which two or more users are engaging or will be engaging. For example, when properties of behavior of users are compared, if two or more users are detected to have at least one property of a behavior in common, the two or more users may be connected in a network based on that at least one common property. If a subsequent user is detected to be engaging (or will engage) in a behavior that has that at least one common property of the network, the subsequent user may also be connected to the network.

For ease of description, exemplary embodiments are described below in connection with behaviors in which users are presently engaging. Embodiments are not limited, however, to only examining behaviors in which users are presently engaging. Embodiments may also examine behaviors in which a user was previously engaged or will be engaged when determining whether to join users in a network based on behavior.

Further, for ease of description, various examples described below will be discussed in the context of determining whether to join two users in a network based on behavior. Embodiments may operate to determine whether to join any number of users in a network based on behavior, including more than two users. Further, as discussed below, in some embodiments users will only be connected in a network when a minimum number of users, which may be more than two users, are engaging in a same behavior.

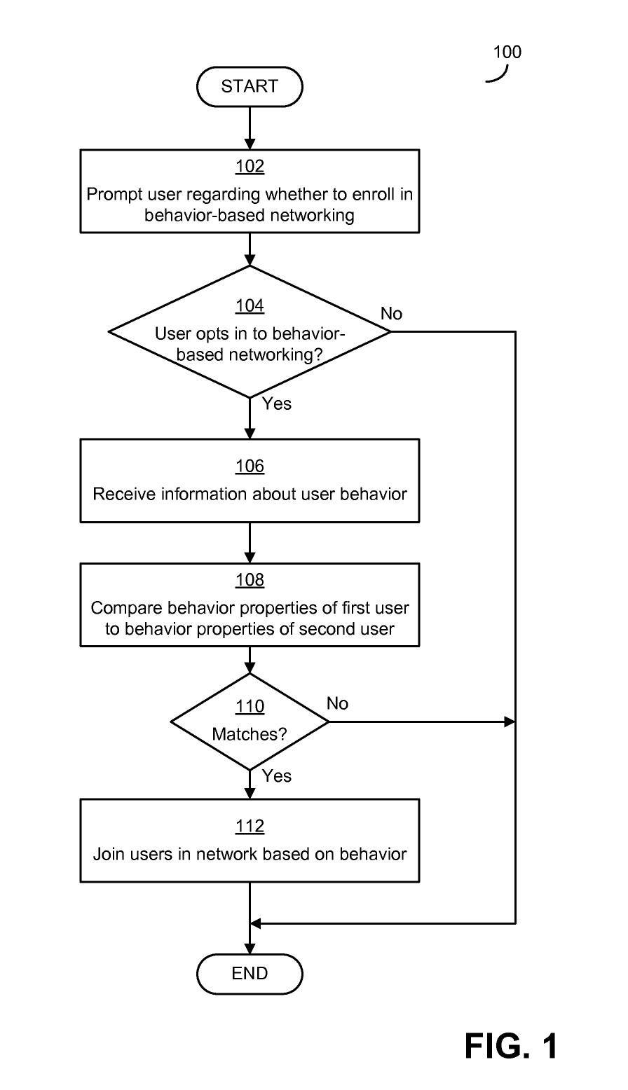

FIG. 1 illustrates one exemplary technique for determining whether at least two users should be connected in a network based on properties of behavior in which the users are engaging. Embodiments are not limited to implementing the illustrative technique shown in FIG. 1, as other techniques are possible.

Process 100 begins in block 102, in which a networking service prompts a user to determine whether the user would like to opt-in to use behavior-based networking and would like to be prompted to join networks of users based on detected similarities in behaviors with other users. This step is important in many embodiments, because information about users, including offline behavior of users, should not be used without a user's consent. If it is detected in block 104 that the user did not consent, then the process 100 ends.

If, however, the user opts-in to the behavior-based networking, in block 106 the networking service receives information about a behavior in which the user is engaging. Any suitable information about behavior may be received, as embodiments are not limited in this respect. In some implementations, the type of information that may be received may differ based on a type of behavior in which the user is engaging. In other implementations, a same set of information may be received for all behaviors. In such other implementations, for example, behavior information may comprise a constant set of data, for all behaviors, the values of which are changed based on the behavior in which the user is engaging.

The networking service may receive information about behavior in any suitable manner from any suitable source. For example, the networking system may receive an explicit user input of the user's behavior by the user describing a behavior in which the user is engaging. As another example, a computing device operated by the user may detect the behavior engaged in by the user and provide information about the behavior to the networking system. The computing device may, for example, identify a location of the user (e.g., a location as indicated by GPS), identify media the user is consuming (e.g., a song the user is listening to via the computing device), identify a web site the user is reading, etc. As another example, a network to which the user's computing device is connected may detect the behavior engaged in by the user and provide information about the behavior. For example, if the user is making a telephone call to a particular destination using a network or is retrieving information over the network (e.g., a wireless telephony network, such as a cellular network), a component attached to the network may detect the behavior and provide to the networking system information about the behavior. Embodiments are not limited to receiving any particular behavior information from any particular source of information.

The information about the behavior may be provided at any suitable time. For example, the information about the behavior may be provided when the user logs in to the networking service. As another example, the behavior information may be provided continuously to the networking system such that the networking system is able to join the user in networks at any time. In some embodiments, the networking service may receive the behavior information without issuing a request for the information, while in other embodiments the networking service may receive the behavior information in response to a request for information. In other embodiments, the networking service may receive some behavior information and may then request additional behavior information. Embodiments are not limited to receiving behavior information at any particular time.

In some embodiments, the manner and/or time at which the information is received may be based on a user selection of what information is to be used or how the information is to be received.

In block 108, once the information about the behavior is received, a comparison is performed to determine whether the behavior in which at least two users are engaging is the same or similar. Behaviors of users may be identified by one or more behavior properties (e.g., location of the behavior, time of the behavior, type of the behavior, or other attributes) that may vary based on a type of behavior in which the user is engaging. To compare the behaviors of the users, a comparison may be performed between behavior properties for the behaviors.

Behavior properties may be determined in any suitable manner. For example, the behavior properties may be parts of the behavior information received in block 106 or may be determined from the behavior information by performing an analysis of the behavior information.

The comparison of block 108 may be performed in any suitable manner. In some embodiments, for each behavior property in common between the user and a second user, a value of the behavior property will be compared. This comparison may be done, in some embodiments, to determine if the behavior property is identical for each. For example, when the behavior is listening to music, a behavior property may be the artist of a presently-playing song or album. When two users are listening to music, the artist behavior property may be compared to determine whether the artists are identical. In some embodiments, instead of or in addition to determine whether the value of the behavior property for the two users is identical, a comparison may be done to determine whether the value of the behavior property for the two users is similar. For example, a behavior property may be a location of the property (e.g., a GPS location), and a comparison may be performed to determine whether the locations of two users are similar. Similar, with regard to location, may mean in some embodiments that the users are within a threshold distance of one another, such as within 100 yards or 10 miles. In some embodiments, rather than performing a one-to-one comparison of behavior properties, a set of two or more behavior properties may be compared to determine whether there is a similarity between values for the set of behavior properties for the behaviors of the users. Any suitable comparison may be performed between behavior properties.

Regardless of the manner in which the comparison is performed, in block 110 a detection is made regarding whether one or more matches were detected in the comparison of block 108. If one or more matches were detected, then in block 112 those matches may form the basis for joining two or more users together in a network. In block 112, the users detected to be engaging in a similar behavior may be prompted with an invitation to join a network based on the detected similarity or may be automatically joined to the network. In some implementations, a determination regarding whether to prompt the user to join or join the user automatically may be based on user input or on any other suitable factor.

Once the users are joined in the network (or have been prompted to join the network) in block 112, or if no match was determined in block 110, the process 100 ends. Following the process 100, if the users are connected, the users may communicate in the network on any suitable topic, including on the behavior in which they are engaged or the experience they are sharing. For example, if a network is formed based on a determination that the users are at a same concert, the users may communicate regarding the concert. Additionally, when the users are connected in the network, an indication of the behavior properties that formed the basis of the network may be stored. For example, if the match that was detected in block 110, and that resulted in the network, is that users are at a same location, the behavior properties indicating the location may be stored as the basis of the network.

As discussed above, in some embodiments the networking service may not make determinations only on behavior in which users are currently engaging, but may additionally or alternatively make determinations regarding behavior in which users will be engaging. The networking system may receive information regarding behaviors in which users will be engaging in any suitable manner. For example, in block 106 of process 100 of FIG. 1, the networking service may receive (if the user consents) information from a user's calendar, to-do list, messaging accounts (e.g., text messages or e-mails), or other data stores indicating plans of the user. The plans of the user may indicate a behavior in which the user will engage at a particular time (e.g., a concert on a Friday night at 8 pm). The networking service may then compare information about plans of the user to information about plans of other users to compare behaviors in which users will engage.

The process 100 of FIG. 1 was discussed in terms of detecting whether to form a network of two or more users based on a detected similarity of behaviors of the users. In some embodiments, a networking service is not limited to determining whether to form a network, but may additionally determine whether to join a user to existing networks based on whether the user is detected to be engaging in behavior that forms the basis of an existing network.

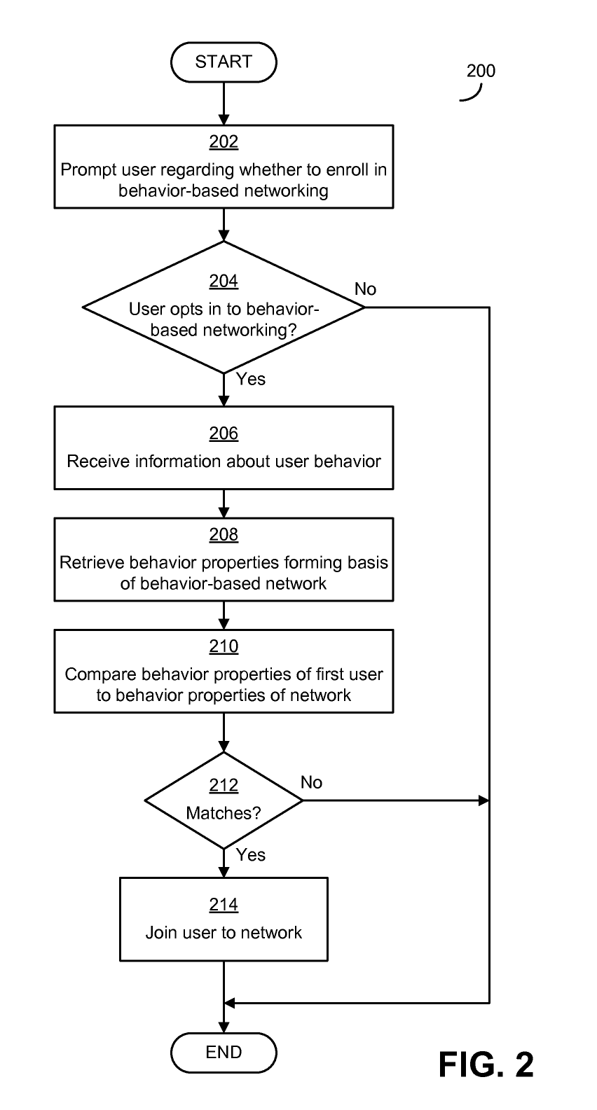

FIG. 2 illustrates one exemplary process 200 that may be implemented in some embodiments to determine whether to join a user to an existing network. In the process 200, the networking service may compare behavior properties of one user to behavior properties of one or more other users, where the other users are connected in a network. In the process 200, the behavior properties of the other users that are used in the comparison may be those properties that have already been used to form a basis of the network in which those other users are connected. When the user is detected to share the behavior properties that form the basis of the network, the user may be prompted to join the network.

The process 200 of FIG. 2 begins in block 202, in which a networking service prompts a user to determine whether the user would like to opt-in to use behavior-based networking and would like to be prompted to join networks of users based on detected similarities in behaviors with other users. As discussed above, this step is important in many embodiments, because information about users, including offline behavior of users, should not be used without a user's consent. If it is detected in block 204 that the user did not consent, then the process 200 ends.

If, however, the user opts-in to the behavior-based networking, in block 206 the networking service receives information about a behavior in which the user is engaging. The information may be received in any suitable manner, from any suitable source, at any suitable time, including according to techniques described above in connection with block 106 of FIG. 1.

In block 208, a set of one or more behavior properties that are the basis of a network of users is retrieved. The set of one or more behavior properties may have been previously determined to identify a common behavior of two or more users, based on a previous analysis of behaviors of users, or may have been created by an administrator of the networking service as a network based on behaviors in which users are expected to engage. For example, the networking service may have previously formed the network based on a determination that users of the networking service are attending a concert, and identified that a particular location is correlated with attending the concert. As another example, an administrator of the networking service may have identified a location of a national park and identified that the location is associated with camping, hiking, etc. The networking service may maintain a network of users based on the properties. In these examples, users that are at the specified location (the location of the concert, or the location of the park) may be detected to be eligible to be in the network.

In block 210, behavior properties relating to the behavior information received in block 206 for the user are compared to the set of behavior properties retrieved in block 208. This comparison is carried out to determine whether the user is engaging in the behavior that forms the basis of the network, and whether the user should be maintained in the network. The comparison may be carried out in any suitable manner, including according to techniques described above in connection with block 108 of FIG. 1.

In block 212, a determination is made as to whether the behavior properties of the user (received in block 206) match the behavior properties that form the basis of the network (retrieved in block 208). If so, then in block 214 the user is prompted to join the network or is automatically joined to the network, and the process 200 ends. If no match was determined in block 212, then the process 200 ends.

The process 200 was described in terms of determining whether to connect a user to a particular pre-existing network, based on the behavior properties that form a basis of that network. In some embodiments, a networking service may maintain multiple networks, and behavior properties may be compared to some or all of the multiple networks. Accordingly, while the process 200 was described as a single comparison, in some embodiments the process 200 may be implemented with a loop to retrieve and compare multiple sets of behavior properties or may be structured in any other way to retrieve and compare multiple sets of behavior properties.

Further, while the processes of FIGS. 1 and 2 are described in terms of joining a user to one other user in a new network or to one existing network, embodiments may operate to determine whether to join a user (and to join a user) to multiple new or existing networks based on the behavior of the user. For example, when a first set of one or more behavior properties of a first user match behavior properties of a second user or match a first existing network, the user may be joined to the second user or the first existing network. When a second set of one or more behavior properties of the first user match behavior properties of a third user or match a second existing network, the user may be additionally joined to the third user or the second existing network. In some such embodiments, a user may be joined to any number of networks. In other embodiments, though, a user may only be joined to a maximum number of networks, including one network, two networks, or any other number.

It should be appreciated that embodiments may implement any suitable process for determining whether behaviors of users are similar or determining whether a behavior of a user is similar to a behavior that forms the basis of an existing network, as embodiments are not limited to performing any particular technique. Accordingly, embodiments are not limited to carrying out either the process 100 of FIG. 1 or the process 200 of FIG. 2.

FIGS. 1 and 2 described connecting users in networks and forming networks based on user behavior. In some embodiments, networking services may also disconnect users and eliminate networks based on user behavior. For example, when a user changes their behavior (e.g., leave a location, or change a song to which they are listening), the networking service may change the networks (and users) to which the user is connected.

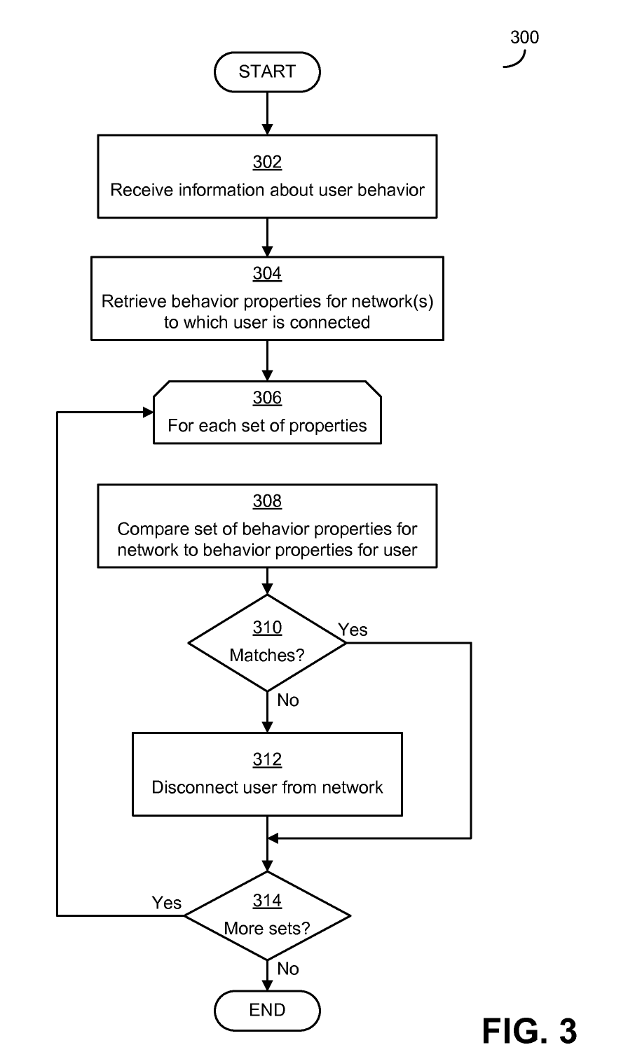

FIG. 3 illustrates one way in which a user may be disconnected from a network, though others are possible. Prior to the start of the process 300, the user has opted-in to behavior-based networking and is connected, via a behavior-based network, to one or more networks.

The process 300 begins in block 302, in which information about a behavior of a user is received. The information about the behavior of the user may include any suitable information about the behavior of the user, such as any of the types of information discussed above in connection with FIGS. 1 and 2. The information about the user may indicate a current behavior of the user, which may be different from a previous behavior, or may indicate a change in the user's behavior.

In block 304, one or more sets of behavior properties are retrieved that are the bases of one or more networks to which the user is connected. The set(s) of behavior properties may be any suitable set that form the basis of a network.

In block 306, a loop is started for each of the network(s) to which the user is connected (i.e., for each of the set(s) of behavior properties retrieved in block 304).

In block 308, the behavior properties relating to the behavior information received in block 302 for the user are compared to each of the set(s) of behavior properties retrieved in block 304. The comparison is performed in block 308, for each network, to determine whether the user's behavior still matches the behavior that forms the basis of the network. The comparison may be made in any suitable manner, including according to techniques described above in connection with blocks 108 and 210 of FIGS. 1 and 2. For example, the comparison may be done to determine whether behavior properties of the user are identical to or similar to behavior properties that form the basis of each network.

In block 310, a determination is made regarding whether the behavior properties of the user still match the behavior properties that form the basis of the network. If so, then the user is left connected to the connected and a determination is made in block 314 regarding whether there are more networks to consider.

If in block 310 a determination is made that the behavior properties of the user do not match the behavior properties that form the basis of the network, then in block 312 the user is disconnected from the network automatically or is prompted to disconnect from the network. If the user disconnects from the network, the user may no longer be able to communicate using the network, but may be given the ability to connect with individual users that were also in the network (e.g., other users with which the user established a relationship) or to re-join the network at another time.

In block 314, a determination is made regarding whether more networks of the user are to be considered. If so, the process 300 returns to block 306 to consider another network and another set of behavior properties. If not, then the process 300 ends.

Once the process 300 ends, other processes may be carried out based on the behavior properties received in block 302. For example, the behavior properties may be used as in processes 100, 200 of FIGS. 1 and 2 to determine whether to join the user in a new network or to an existing network based on the behavior of the user.

In addition to determining whether a user should be disconnected from a network, embodiments may also determine whether a network should be eliminated from the networking system. Networks that are formed based on behaviors of users may be eliminated when users are no longer engaging in those behaviors.

Process 400 illustrates one process that may be implemented for eliminating a network based on a behavior of a user. In embodiments in which the process 400 may be implemented, a network may be formed when more than a minimum number of users and less than a maximum number of users are detected to be engaging in a behavior. Such minimums and maximums may be used to form networks in which users are likely to communicate, as too few or too many users may make the network not useful.

Process 400 begins in block 402, in which a change in user behavior is detected. The change in user behavior may be detected based on receiving information about a behavior engaged in by a user. In block 404, a determination is made whether a user was added to an existing network or removed from an existing network based on the change in behavior. The determination of block 404 may be made in any suitable manner, including according to the comparisons of blocks 108, 210, and 308 of FIGS. 1-3.

If the user is added to an existing network, then a determination is made in block 406 regarding whether the maximum number of users has been exceeded for the existing network. If the maximum is exceeded, then in block 410 the network may be eliminated and the process 400 ends. If the maximum is not exceeded, then the process 400 ends.

If the user is removed from an existing network, then a determination is made in block 408 regarding whether the minimum number of users is still exceeded for the existing network. If the minimum is not exceeded, then in block 410 the network may be eliminated and the process 400 ends. If the minimum is exceeded, then the process 400 ends.

While the process 400 is described as managing networks based only on a number of users, in some embodiments other factors may additionally be considered when determining how to manage existing networks. For example, a determination may be made regarding whether users of the existing network are communicating in the network. If users are communicating in the network, then the network may not be eliminated or a threshold may be adjusted for that particular network to permit users to continue communicating. If the thresholds are adjusted and the adjusted thresholds are then not met, the existing network may be eliminated.

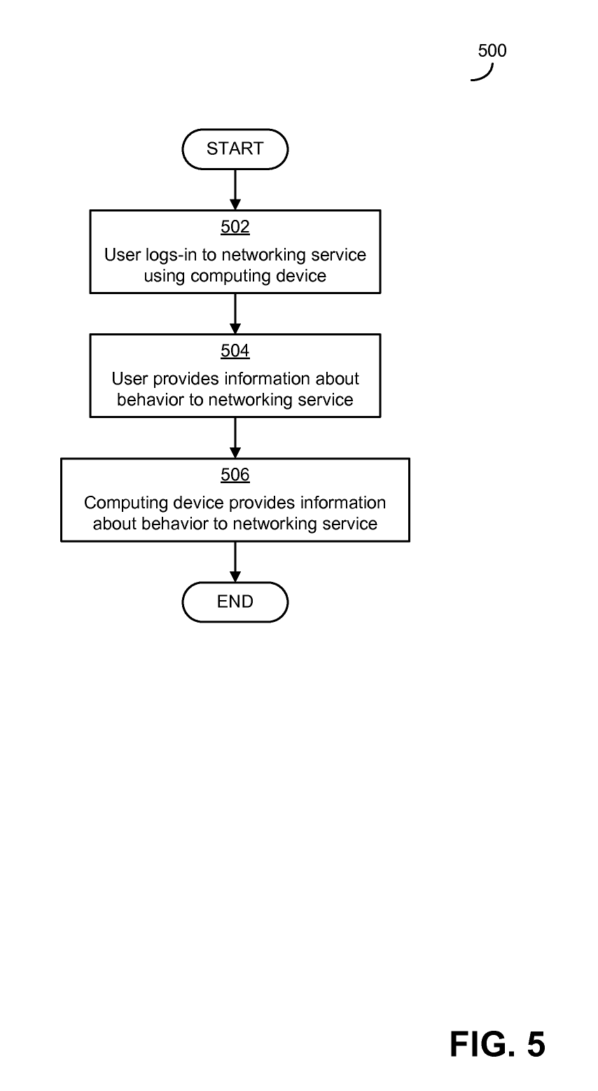

The exemplary processes discussed above include receiving information about a behavior of a user to make determinations about behavior-based networks. Embodiments of the invention are not limited to receiving behavior information in any particular manner, or to receiving any particular behavior information. Rather, the networking service may receive information about a behavior of a user in any suitable manner. FIG. 5 shows one way in which a networking service may receive information about a user.

Process 500 of FIG. 5 begins in block 502, in which a user operates a computing device to log on to a networking service. The user may log on to the networking service in any suitable manner, including by providing credentials to the networking service. To log on to the networking service, the user may use a stand-alone application, a web browser, or any other suitable application executing on the computing device.

In block 504, the user may input information to the computing device describing a behavior in which the user is engaging, and use the computing device to transmit the information to the networking service. The information provided by the user may include a description of an activity, a description of the user's location, a description of an event, or any other description of the behavior in which the user is engaging.

In block 506, the computing device operated by the user may automatically transmit some information to the networking service about the behavior in which the user is engaging. The information provided by the computing device may include a location of the user (and the computing device), an indication of a movement of the user (e.g., a speed or direction of the user's movements), an indication of a type or model of the computing device the user is operating, a way in which the computing device is being operated (e.g., to retrieve a particular web page, or consume a particular media), or other suitable information relating to the behavior of the user. The information transmitted by the computing device in block 506 may result from determinations made by the computing device, such as determinations from sensors of the computing device (e.g., a GPS receiver of the computing device) or information retrieved from memory indicating a state of the computing device (e.g., information indicating an artist for a song presently being played by the computing device). The computing device may automatically transmit some information to the networking service based on a command from a user, an instruction from an application executing on the computing device, a command received over a network, or in response to any other condition.

Once the computing device transmits the information in block 506, the process 500 ends. The networking service, upon receiving the information, may prompt the user to join a network or join the user to a network, and the user may subsequently operate the computing device to communicate in the network.

It should be appreciated that while FIG. 5 illustrates receiving two types of information at a networking service, in some embodiments the networking service may not receive both types of information or may receive other types of information. For example, a networking service may receive information automatically provided by the computing device but not information provided by the user. As another example, a networking service may receive information from a network to which the computing device is connected, such as a telephony network to which the computing device is connected. The information from the network may indicate a location of a user (e.g., in a cellular network, a location based on a nearest cellular tower), a way in which the user is interacting with the network (e.g., information being retrieved over a network), or any other suitable information. The types of information that are received by the networking service may, in some embodiments, be based on user input regarding what types of information about the user's behavior should be provided to the networking service. This would allow the user to control what information the networking service is able to access.

The techniques described above also include on comparing behavior information and behavior properties relating to behavior of users. A networking service may compare behavior information about users in any suitable manner and may use the results of such a comparison to determine in any suitable manner whether to join a user to one or more other users in a network or to disconnect users from networks. Embodiments are not limited to any particular technique for performing the comparisons to manage behavior-based networking.

Some embodiments may not perform a comparison of behavior information and subsequently join users based on any matched characteristics. Rather, in some embodiments, a networking service may join users when the matched characteristics are determined to be likely to result in a network that will be beneficial to users. For example, in such embodiments a networking service may determine not to join users in a network when two or more users are determined to be using their home computers to listen to music. The networking service may determine that the users are engaging in a similar behavior (listening to music), but may determine that such behavior is not likely to form a basis of a network that users will use to communicate to one another. This may be because the users would not feel like they are not sharing an “experience” merely by listening to music, and thus would not be inclined to communicate to other users in a network based on this property alone. On the other hand, users detected to be listening to a same album on their home computers may be inclined to communicate to other users about the album. When the networking service detects users listening to a same album, then, the networking service may form a network based on this behavior.

Similarly, users detected to be in a same location within 100 yards of one another (i.e., very close to one another, and therefore possible in the same space) may be inclined to communicate, and users detected to be in a same location within 100 miles of one another (i.e., possibly very far from one another) may not be inclined to communicate. Thus, some networking services may form a network based on the former and not based on the latter.

Thus, in some embodiments a networking service may perform a comparison in a way that determines whether a match between behaviors is likely to result in a network in which users will communicate. Such a comparison may be carried out in any suitable manner. Embodiments may use any suitable learning, mapping, or artificial intelligence technique to make a comparison between information known about two behaviors to determine whether the behaviors are similar and whether a network based on those behaviors will result in a network in which users will communicate.

In some embodiments, a comparison of behavior properties of users may include calculating a value that indicates a strength of a match between behavior properties. The match value may be used to connect users in a network when the match value exceeds a threshold, or may be used to disconnect users in a network when the match value falls beneath a threshold. In some embodiments, the match value may also be used to determine whether to form a new network or eliminate an existing network. In some implementations, different thresholds may be used for determining whether to create new networks and for determining whether to join a user to an existing network, and for determining whether to disconnect a user from an existing network and for determining whether to eliminate a network.

Embodiments that use such match values may calculate the match values in any suitable manner. The match values may be calculated based on the comparison of the behavior properties as well as on any other suitable information about a user or about networks. As discussed in greater detail below, in some embodiments, performing a comparison of a behavior property for two users may include calculating a property match value identifying a strength of a match between the value of the behavior property for each of the two users and/or applying weighting factors to the property match value that identify how likely that behavior property is to result in a network in which users will communicate. An overall match value for the comparison between the behaviors of the two users may then be based on a calculation involving some or all of the property match values.

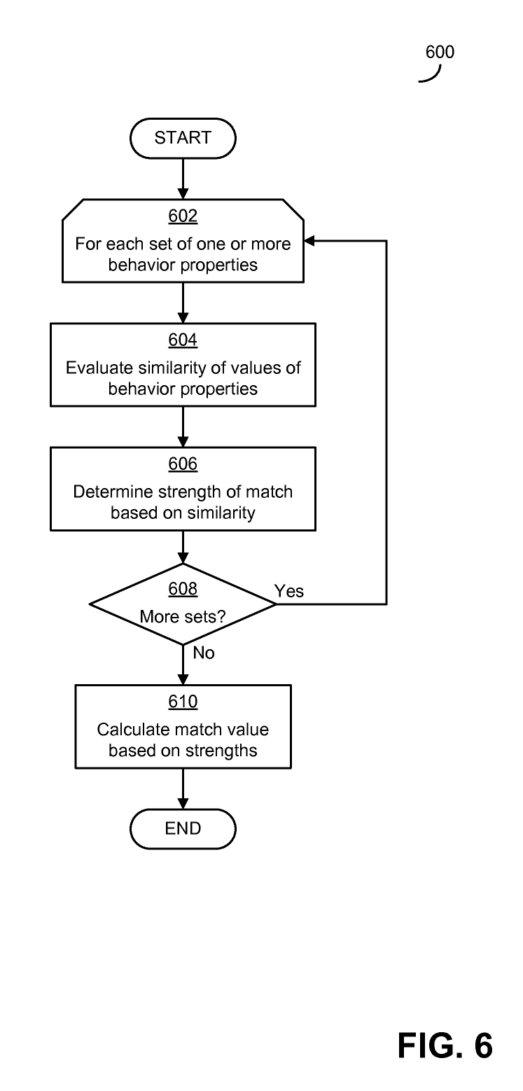

FIG. 6 illustrates one exemplary process that may be implemented in some embodiments for calculating a strength of a match when comparing values for behavior properties. Embodiments that implement techniques for calculating match values are not limited to implementing the technique shown in FIG. 6, however, as others are possible.

The process 600 begins in block 602, in which a loop is started for evaluating behavior properties or sets of behavior properties known about a behavior of a user. The behavior properties included in the loop may be all of the behavior properties known about a user or may be limited in some way. For example, in some embodiments, when a comparison is to be made between behavior properties of a first user and behavior properties of a second user, the loop may include behavior properties that are common to each of the users. As another example, when a comparison is to be made between behavior properties of a first user and behavior properties that form a basis of an existing network, the behavior properties that form the basis of the existing network may be considered. Further, behavior properties can be grouped in any suitable manner for comparison. Behavior properties may be evaluated as a one-to-one evaluation or may be evaluated in any suitable set of one, two, or more behavior properties.

Once a set of one or more behavior properties is selected in block 602, the set of behavior properties are evaluated in block 604. In block 604, the set of behavior properties for at least two users are evaluated to determine a similarity of the behavior properties. The behavior properties evaluated may be any suitable behavior properties, including exemplary types of behavior properties described above. Evaluating the similarity of the behavior properties may be done in any suitable manner, including evaluating values of behavior properties and/or evaluating types of behavior properties.

Different types of evaluations of similarity may be carried out for different behavior properties or different sets of behavior properties. For example, when a location of users is compared for a behavior property, a distance between the locations of the users may be evaluated to determine a similarity. Locations that are closer together may be determined to be more similar. As another example, when the behavior properties relate to music to which users are listening to on their home computers, an artist, album, and song may be evaluated to determine a similarity between the music. In this example, if an artist is the same, but album and song are different, the behavior properties may be determined to be less similar than if album and song are the same. In embodiments that consider behavior properties relating to playing of music, a history of songs played may also be considered. In this way, if a user is detected to be listening to a particular song, but that song was played as a result of a “shuffle” command, the behavior properties (and thus the behavior) may be detected to be less similar to behavior properties of another user that is listening to the song as part of the entire album.

As discussed above, in embodiments, the networking service will compare behavior properties of behaviors in which users are engaging to determine whether the users are sharing a same experience and whether to form behavior-based networks based on the behaviors. Any suitable evaluation of similarity may be carried out for any suitable behavior properties to determine a similarity between the properties of the purposes of detecting when users are engaging in similar behavior.

In block 606, after the evaluation of block 604, a strength of a match between behavior properties is determined based on the evaluation of the similarity. The strength of the match may be a value indicating a degree of similarity between behavior properties. In some implementations, the value may be a value indicating a probability of a match, such as a value between 0 and 1 indicating a likelihood that the behavior properties (and therefore the behaviors) are the same. The strength of the match may be output as a result of the evaluation of block 604 and identified in block 606 as the strength of the match, of the strength of the match may be calculated in block 606 based on any suitable output of block 604.

Once the strength of the match is determined in block 606, a determination is made in block 608 regarding whether other sets of one or more behavior properties are to be examined. If so, the process 600 returns to block 602 to select another set of behavior properties. If not, the process 600 continues to block 610 to calculate an overall match value for the behavior properties.

As discussed above, the process 600 may be carried out for each set of one or more behavior properties to determine whether behavior of users is similar. To do so, an overall match value for the behaviors of the users may be determined from the strength of matches that were identified for each of the behavior properties. The overall match value may, for example, be calculated from the strengths of the matches for each of the behavior properties, such as by summing or multiplying the strengths.

The overall match value may indicate an overall similarity between behaviors of users.

Once the overall match value is calculated in block 610, the process 600 ends. The overall match value calculated in block 610, based on the strength of similarities between behavior properties, may then be used to determine how to manage connections of a user to networks. For example, if the overall match value between two users exceeds a threshold, the behaviors of the users may be determined to be a match and the users may be connected in a network. As another example, if an overall match value exceeds a threshold, a user may be connected to an existing network. As another example, if the overall match value does not exceed a threshold, the behavior of the users may be determined not to be a match and the users may not be connected, or a user may be disconnected from a network to which the user was previously connected.

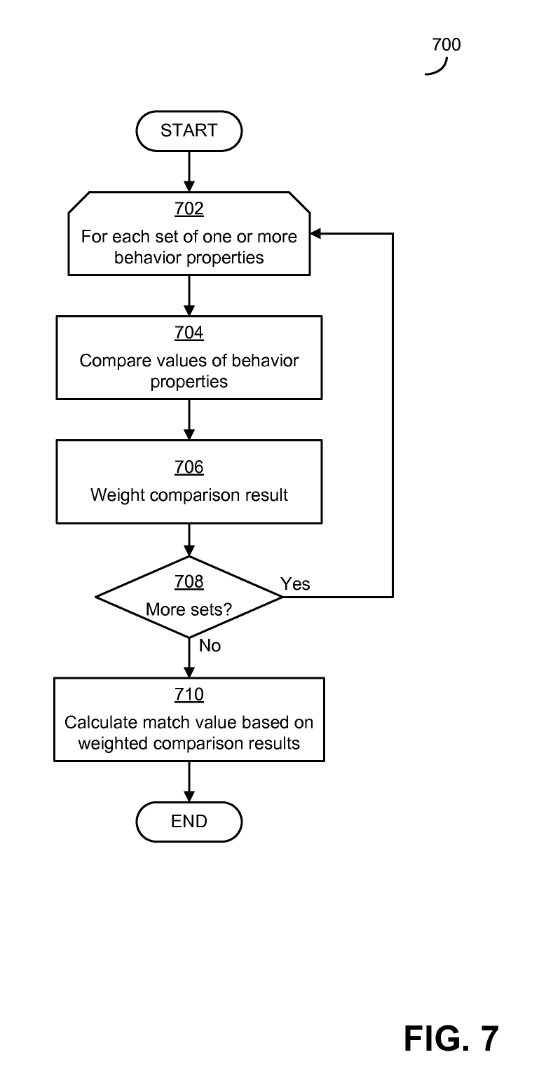

FIG. 7 illustrates an exemplary process that may be implemented in some embodiments for weighting matches between behavior properties when comparing values for behavior properties. Embodiments that implement techniques for calculating match values are not limited to implementing the technique shown in FIG. 7, however, as others are possible.

Process 700 of FIG. 7 begins in block 702, in which a loop is started for evaluating behavior properties or sets of behavior properties known about a behavior of a user. Any suitable behavior properties may be considered alone or in any suitable combination, including according to any of the arrangements discussed in connection with block 602 of FIG. 6.

Once a set of one or more behavior properties is selected in block 702, the set of behavior properties are comparison in block 704. In block 704, the set of behavior properties for at least two users are compared to determine whether there is a match in the behavior properties. The comparison of block 704 may be carried out in any suitable manner, including any of the exemplary techniques described above. In some embodiments, the comparison of block 704 may be carried out using techniques described above in connection with FIG. 6, such that a strength of a match is determined based on a similarity of behavior properties.

Once the comparison is carried out in block 704, a result of the comparison is weighted in block 706 according to a weighting factor for the behavior property or behavior properties compared in block 704. The weighting factor may indicate a likelihood that a network based on those behavior properties will be used by users to communicate. In this way, if a property has a high likelihood of resulting in a network that will be used by users, the property may be weighted higher than a property that has a low likelihood of resulting in a network that will be used by users. For example, if users are determined to be more likely to communicate with other users sharing a same location, but less likely to communicate with other users listening to a same song, then a location behavior property may be weighted higher than a song behavior property. The weighting factors may be stored as any suitable value, including as a value between 0 and 1.

The weighting of block 706 may be carried out in any suitable manner, and in some embodiments may be dependent on the manner in which the comparison of block 704 is carried out. For example, if the comparison of block 706 resulted in a determination that the values of the behavior property compared are identical, then the weighting factor may be identified and stored as the property match value for the behavior property. As another example, if the comparison of block 706 resulted in a value indicating a strength of a match between the behavior properties, as in FIG. 6 above, then the weighting factor may be multiplied by the strength of the match to yield a weighted match strength. The weighted match strength may then be stored as the property match value for the behavior property.

Once the weighting factor is used to determine the property match value in block 706, a determination is made in block 708 regarding whether other sets of one or more behavior properties are to be examined. If so, the process 700 returns to block 702 to select another set of behavior properties. If not, the process 700 continues to block 710 to calculate an overall match value for the behavior properties. The overall match value may be calculated in any suitable manner, including according to techniques described above in connection with block 610 of FIG. 6. For example, the overall match value may be based on a calculation involving the property match values, such as by adding or multiplying the property match values.

Once the overall match value is calculated in block 710, the process 700 ends. The overall match value calculated in block 710, based on the strength of similarities between behavior properties, may then be used to determine how to manage connections of a user to networks. For example, if the overall match value between two users exceeds a threshold, the behaviors of the users may be determined to be a match and the users may be connected in a network. As another example, if an overall match value exceeds a threshold, a user may be connected to an existing network. As another example, if the overall match value does not exceed a threshold, the behavior of the users may be determined not to be a match and the users may not be connected, or a user may be disconnected from a network to which the user was previously connected.

In embodiments that perform calculations when performing comparisons between behavior properties, the calculations may be performed in any suitable manner. In some cases, the calculations may use various system constants or other system values in making the calculations. The system values may be used, for example, to adjust determinations of strengths of matches or as weighting factors. For example, a system value may be used to determine a strength of a match based on location, such as where the strength is proportional to a system value and the distance between locations of users (e.g., the distance multiplied by the system value). As another example, a system value may be used as a weighting factor, such as where the system value indicates a likelihood that users will communicate in a network based on a particular behavior property.

These system values may be derived from any suitable source. In some cases, the system values may be based on input from an administrator. In other cases, the system values may be additionally or alternatively based on input from a user, such as input regarding a user's network preferences. In other cases, the system values may be additionally or alternatively be based on conditions in the networking service, such as information determined by the networking service from monitoring use of the networking service.

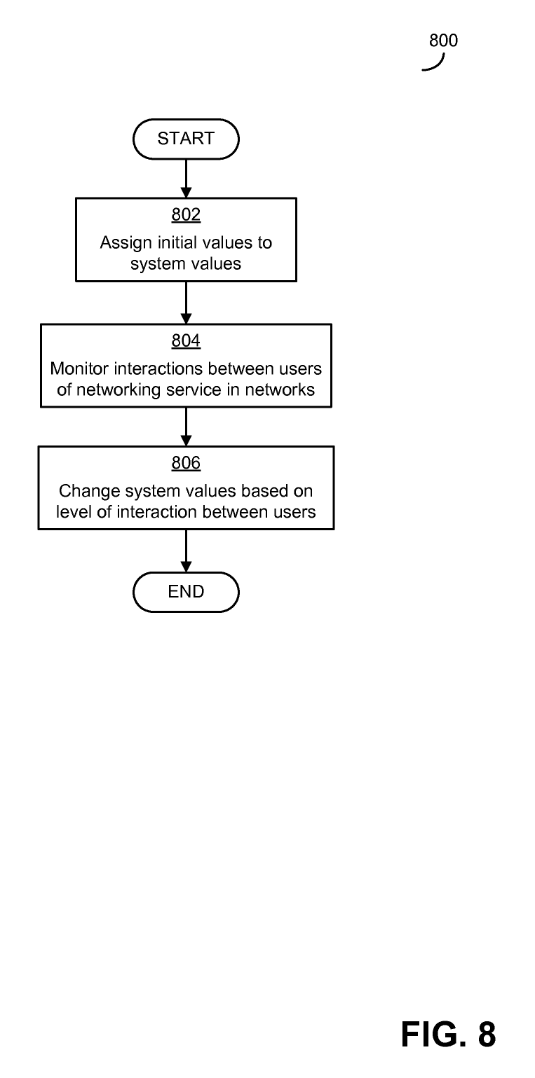

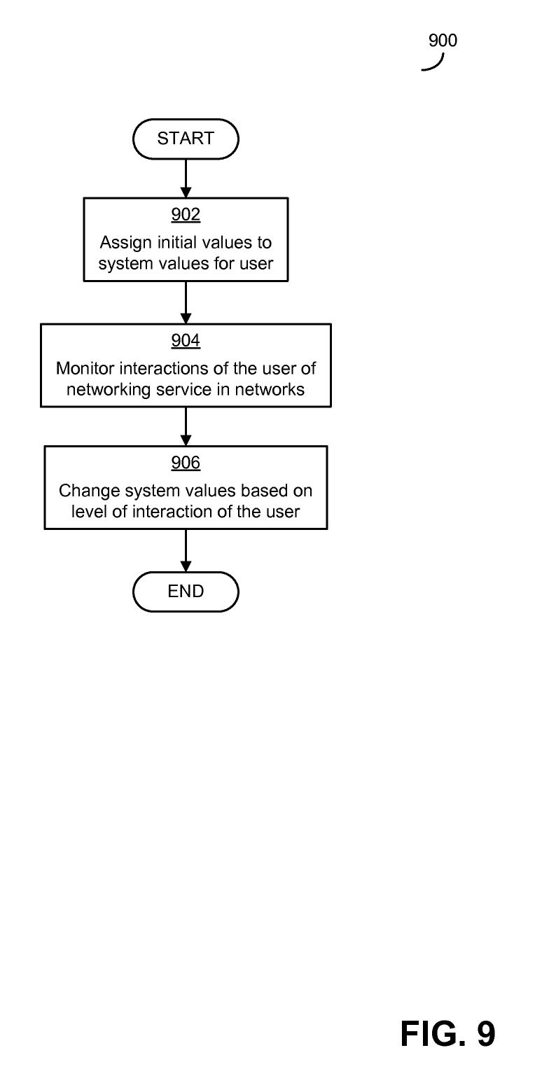

FIGS. 8 and 9 show two exemplary ways in which system values may be adjusted by a networking service based on conditions in the networking service. Embodiments are not limited, however, to implementing either or both of the processes described in connection with FIGS. 8 and 9.

The process 800 of FIG. 8 begins in block 802, in which initial values are assigned to system values. The initial values may be assigned in any suitable manner, including being assigned by an administrator or being assigned a uniform default value (e.g., 1).

In block 804, the networking service forms behavior-based networks based on behavior properties and monitors interactions of users in behavior-based networks. The interactions of the users may include communications directly between users or communications between groups of users in the network, examining information shared in the network, or otherwise interacting with the network.

In block 806, the networking system adjusts, based on detected levels of interactions in behavior-based networks, the system values that were used in creating the behavior-based networks. For example, if a behavior-based network is formed and users do not interact in that network, the networking service may detect that the network was improperly formed and may operate to avoid forming that network in the same manner in the future. System values (e.g., values used in similarity calculations or weighting factors) may therefore be adjusted to decrease the likelihood of that network being formed again based only on those factors. For example, where weighting factors are used, a weighting factor associated with each of the behavior properties or with the set of behavior properties that formed the basis for the network may be reduced. On the other hand, if a behavior-based network is formed and users interact a great deal in that network, the networking service may detect that the network was properly formed and may operate to encourage formation of that network again. System values may therefore be adjusted to increase the likelihood of that network being formed again. For example, where weighting factors are used, a weighting factor associated with each of the behavior properties or with the set of behavior properties that formed the basis for the network may be increased.

Once the system values are adjusted in block 806, the process 800 ends.

The process 900 of FIG. 9 is similar to the process 800 of FIG. 8 in some ways. However, while in the process 800 the system values for the entire system were adjusted, in the process 900 a networking service may associate particular system values with each user, such that user preferences may be taken into account when determining whether to join a user to behavior-based networks. Embodiments may implement one or both of the processes 800 and 900 to change system values.

Process 900 begins in block 902, in which initial values are assigned to system values associated with the user. In some implementations, the initial values may be default values used by the networking system, while in other implementations, the initial values may be system values determined by the networking service based on interactions of other users, such as using the process 800 of FIG. 8.

In block 904, the networking system monitors interactions between the user and users in networks to which the user is joined and, based on detected levels of interactions of the user, in block 906 adjusts the system values that were used in creating the behavior-based networks. For example, if the user is joined to others in a behavior-based network and the user does not interact in that network, the networking service may detect that the user is not interested in networks of that type and may operate to avoid connecting the user to such a network in the same manner in the future. System values (e.g., values used in similarity calculations or weighting factors) may therefore be adjusted to decrease the likelihood of the user being connected in that type of network again based only on those factors. The system values may be adjusted in any suitable manner, including according to techniques described above in connection with block 806 of FIG. 8.

Once the system values are adjusted in block 906, the process 900 ends.

In embodiments that adjust system values that are used in determining whether to join users to networks, a change in the system value may result in other actions being taken by the networking service. For example, as discussed above, in some embodiments a user may be connected in a network when a similarity of behavior exceeds a threshold and may be disconnected from a network when the similarity of behavior (e.g., following a change in behavior) drops below a threshold. When system values are used in a networking service to determine match values that are compared to these thresholds, then a change in a system value may result in a change to a match value, which may in turn lead to the match value exceeding or dropping below a threshold. Accordingly, a change in a system value may lead to a different determination of a similarity in user behavior and changes in connections of users to networks.

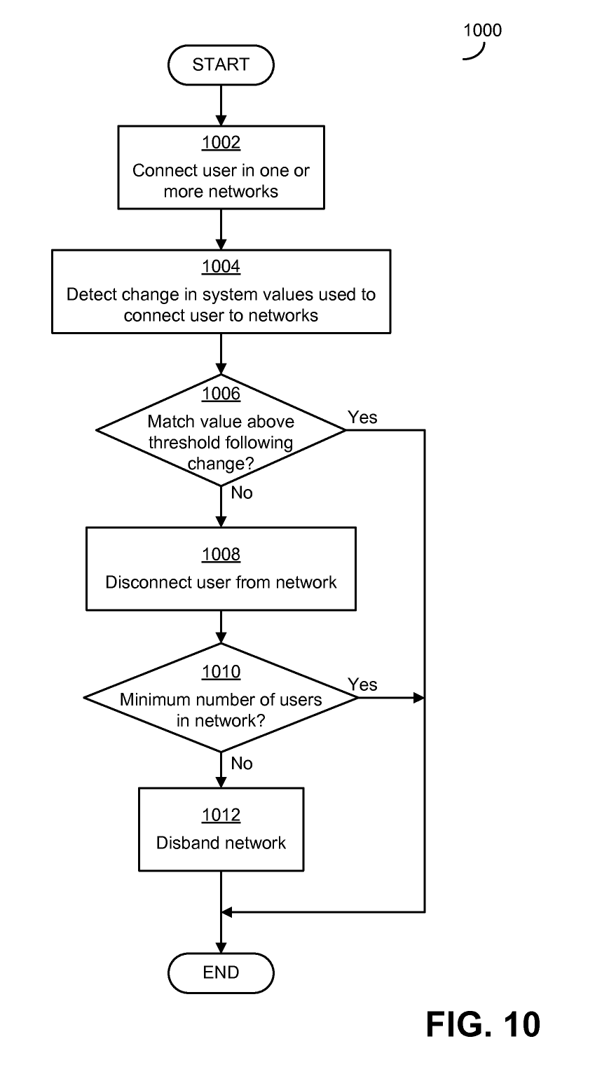

FIG. 10 shows one exemplary process for detecting whether to disconnect users and/or eliminate networks based on changes in system values. The process 1000 may be carried out following a change to a system value (e.g., a system value for the service, as in FIG. 8, and/or a system value for a user, as in FIG. 9). Embodiments are not limited to implementing the process 1000 of FIG. 10, as others are possible.

Process 1000 begins in block 1002, when a user is joined to at least one behavior-based network based on a detection of a similarity in the user's behavior to behavior of other users. The detection of similarity may be carried out in any suitable manner, including according to techniques described above.

In block 1004, a change of system values is detected. The change of system values may have been prompted by any suitable determination, such as a determination made about levels of interactions in networks managed by the networking service, and may be carried out in any suitable manner. In some embodiments, the system values may be edited using techniques described above in connection with one or both of FIGS. 8 and 9. A change in the system values may be followed by a recalculation of match values between the behavior of the user and the other users to which the user is connected in the network(s).

In block 1006, once the system values have been recalculated, for each network a determination is made regarding whether the match value between the user's behavior and the behavior of other users is above the threshold, and whether the user should remain connected to the other users. If the match value is above the threshold, then the user is not disconnected from the network and the process 1000 ends.

If, however, the match value is now below the threshold because of the change in the system values, then in block 1008 the user may be disconnected from the network because the user's behavior is no longer sufficiently similar to the other users for the user to remain connected to the other users.

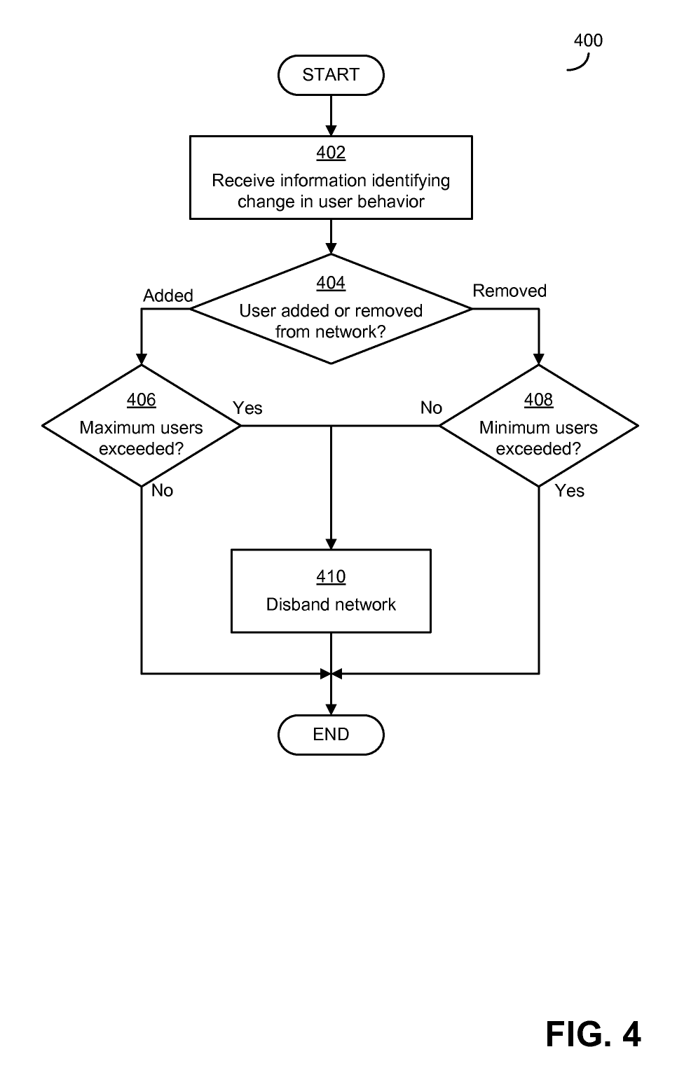

When the user is disconnected from the network, in block 1010 a determination may also be made regarding whether the network should continue to exist in the networking service. As discussed above in connection with FIG. 4, in some embodiments a network will only be maintained by the networking service when certain conditions are met, including that the network includes more than a minimum number of users. If, following the disconnection of the users in block 1008, the network no longer has the minimum number of users—or some other condition for the network is not met—then in block 1012 the network may be disbanded. Once the network has been disbanded in block 1012, or if a determination is made in block 1010 that the network should not be disbanded, the process 1000 ends.

Techniques operating according to the principles described herein may be implemented in any suitable manner. Included in the discussion above are a series of flow charts showing the steps and acts of various processes that permit users to connect to and interact in behavior-based networks. The processing and decision blocks of the flow charts above represent steps and acts that may be included in algorithms that carry out these various processes. Algorithms derived from these processes may be implemented as software integrated with and directing the operation of one or more multi-purpose processors, may be implemented as functionally-equivalent circuits such as a Digital Signal Processing (DSP) circuit or an Application-Specific Integrated Circuit (ASIC), or may be implemented in any other suitable manner. It should be appreciated that the flow charts included herein do not depict the syntax or operation of any particular circuit, or of any particular programming language or type of programming language. Rather, the flow charts illustrate the functional information one of ordinary skill in the art may use to fabricate circuits or to implement computer software algorithms to perform the processing of a particular apparatus carrying out the types of techniques described herein. It should also be appreciated that, unless otherwise indicated herein, the particular sequence of steps and acts described in each flow chart is merely illustrative of the algorithms that may be implemented and can be varied in implementations and embodiments of the principles described herein.

Accordingly, in some embodiments, the techniques described herein may be embodied in computer-executable instructions implemented as software, including as application software, system software, firmware, middleware, or any other suitable type of software. Such computer-executable instructions may be written using any of a number of suitable programming languages and/or programming or scripting tools, and also may be compiled as executable machine language code or intermediate code that is executed on a framework or virtual machine.

When techniques described herein are embodied as computer-executable instructions, these computer-executable instructions may be implemented in any suitable manner, including as a number of functional facilities, each providing one or more operations needed to complete execution of algorithms operating according to these techniques. A “functional facility,” however instantiated, is a structural component of a computer system that, when integrated with and executed by one or more computers, causes the one or more computers to perform a specific operational role. A functional facility may be a portion of or an entire software element. For example, a functional facility may be implemented as a function of a process, or as a discrete process, or as any other suitable unit of processing. If techniques described herein are implemented as multiple functional facilities, each functional facility may be implemented in its own way; all need not be implemented the same way. Additionally, these functional facilities may be executed in parallel or serially, as appropriate, and may pass information between one another using a shared memory on the computer(s) on which they are executing, using a message passing protocol, or in any other suitable way.

Generally, functional facilities include routines, programs, objects, components, data structures, etc. that perform particular tasks or implement particular abstract data types. Typically, the functionality of the functional facilities may be combined or distributed as desired in the systems in which they operate. In some implementations, one or more functional facilities carrying out techniques herein may together form a complete software package, for example as a web-based social networking service. These functional facilities may, in alternative embodiments, be adapted to interact with other, unrelated functional facilities and/or processes, to implement a software program application. In other implementations, at least some of the functional facilities may be adapted to interact with other functional facilities in such a way as form an operating system, including the Windows Mobile operating system, available from the Microsoft Corporation of Redmond, Wash. In other words, in some implementations, the functional facilities may be implemented alternatively as a portion of or outside of an operating system.

Some exemplary functional facilities have been described herein for carrying out one or more tasks. It should be appreciated, though, that the functional facilities and division of tasks described is merely illustrative of the type of functional facilities that may implement the exemplary techniques described herein, and that embodiments are not limited to being implemented in any specific number, division, or type of functional facilities. In some implementations, all functionality may be implemented in a single functional facility. It should also be appreciated that, in some implementations, some of the functional facilities described herein may be implemented together with or separately from others (i.e., as a single unit or separate units), or some of these functional facilities may not be implemented.

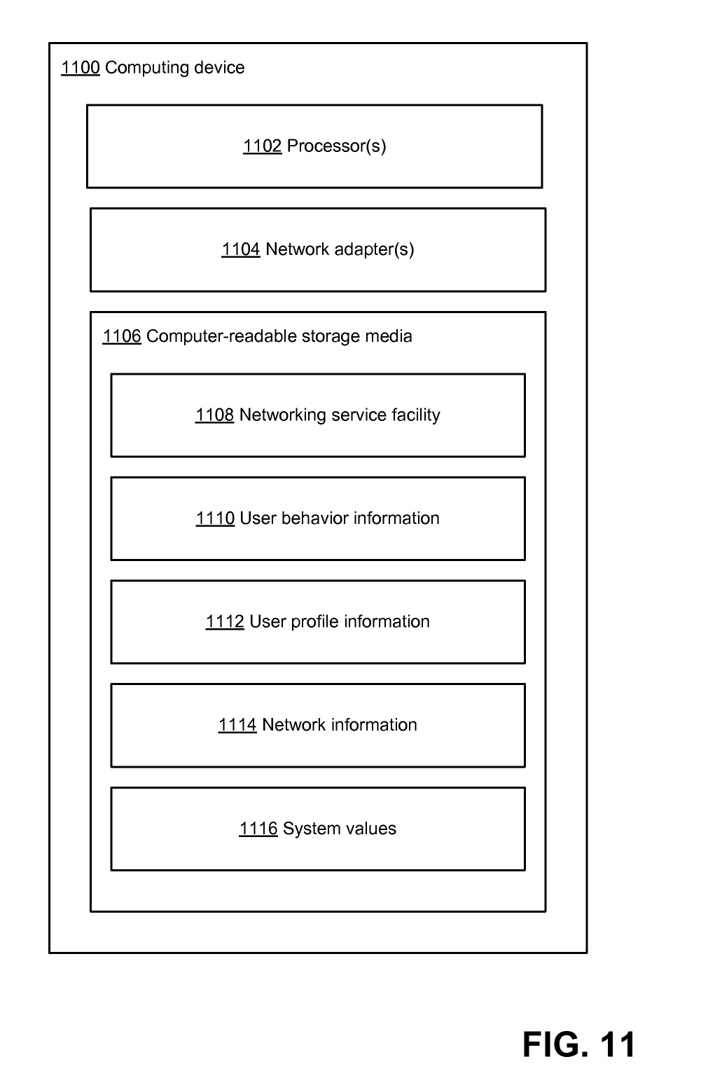

Computer-executable instructions implementing the techniques described herein (when implemented as one or more functional facilities or in any other manner) may, in some embodiments, be encoded on one or more computer-readable media to provide functionality to the media. Computer-readable media include magnetic media such as a hard disk drive, optical media such as a Compact Disk (CD) or a Digital Versatile Disk (DVD), a persistent or non-persistent solid-state memory (e.g., Flash memory, Magnetic RAM, etc.), or any other suitable storage media. Such a computer-readable medium may be implemented in any suitable manner, including as computer-readable storage media 1106 of FIG. 11 described below (i.e., as a portion of a computing device 1100) or as a stand-alone, separate storage medium. As used herein, “computer-readable media” (also called “computer-readable storage media”) refers to tangible storage media. Tangible storage media are non-transitory and have at least one physical, structural component. In a “computer-readable medium,” as used herein, at least one physical, structural component has at least one physical property that may be altered in some way during a process of creating the medium with embedded information, a process of recording information thereon, or any other process of encoding the medium with information. For example, a magnetization state of a portion of a physical structure of a computer-readable medium may be altered during a recording process.

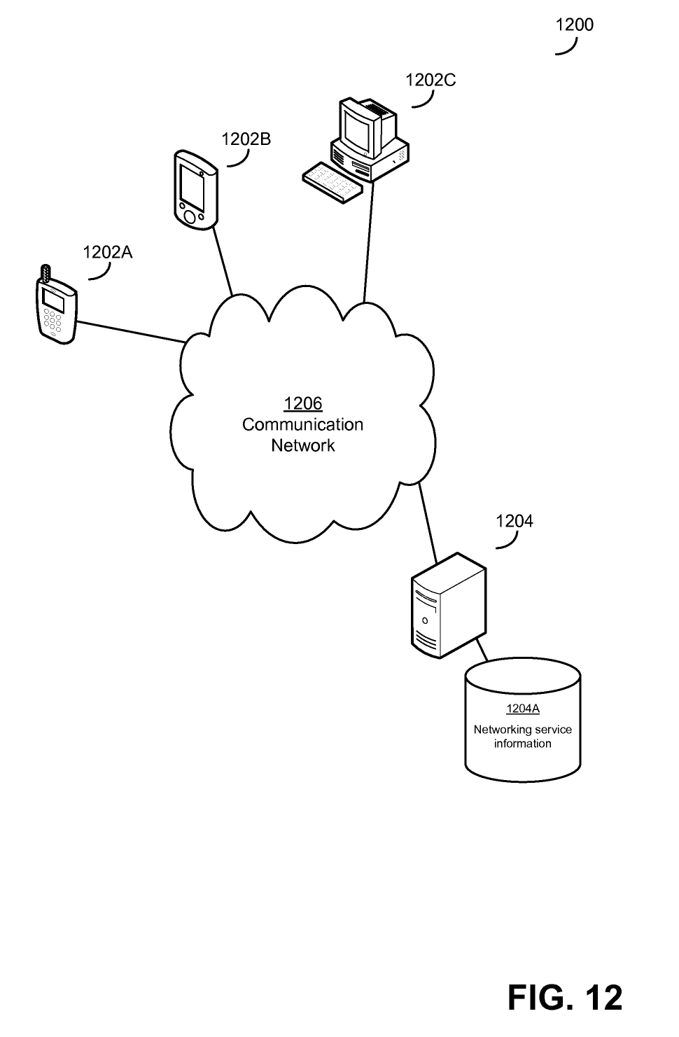

In some, but not all, implementations in which the techniques may be embodied as computer-executable instructions, these instructions may be executed on one or more suitable computing device(s) operating in any suitable computer system, including the exemplary computer system of FIG. 12. Functional facilities that comprise these computer-executable instructions may be integrated with and direct the operation of a single multi-purpose programmable digital computer apparatus, a coordinated system of two or more multi-purpose computer apparatuses sharing processing power and jointly carrying out the techniques described herein, a single computer apparatus or coordinated system of computer apparatuses (co-located or geographically distributed) dedicated to executing the techniques described herein, one or more Field-Programmable Gate Arrays (FPGAs) for carrying out the techniques described herein, or any other suitable system.

FIG. 11 illustrates one exemplary implementation of a computing device in the form of a computing device 1100 that may be used in a system implementing the techniques described herein, although others are possible. It should be appreciated that FIG. 11 is intended neither to be a depiction of necessary components for a computing device to operate in accordance with the principles described herein, nor a comprehensive depiction.

Computing device 1100 may comprise at least one processor 1102, a network adapter 1104, and computer-readable storage media 1106. Computing device 1100 may be, for example, a desktop or laptop personal computer, a server, a distributed set of computers linked together and sharing processing responsibilities as a single logical computer, or any other suitable computing device. Network adapter 1104 may be any suitable hardware and/or software to enable the computing device 1100 to communicate wirelessly with any other suitable computing device over any suitable computing network. The computing network may include a wireless access point as well as any suitable wired and/or wireless communication medium or media for exchanging data between two or more computers, including the Internet. Computer-readable media 1106 may be adapted to store data to be processed and/or instructions to be executed by processor 1102. Processor 1102 enables processing of data and execution of instructions. The data and instructions may be stored on the computer-readable storage media 1106 and may, for example, enable communication between components of the computing device 1100.

The data and instructions stored on computer-readable storage media 1106 may comprise computer-executable instructions implementing techniques which operate according to the principles described herein. In the example of FIG. 11, computer-readable storage media 1106 stores computer-executable instructions implementing various facilities and storing various information as described above. Computer-readable storage media 1106 may store data and/or instructions for a networking service facility 1108. The networking service facility 1108 may include instructions for receiving behavior information from users, connecting users in behavior-based networks, managing the networks, and facilitating communication between users in the networks. To manage the networks, the networking service facility 1108 may process information include user behavior information 1110 describing behaviors in which the users are or will be engaging, user profile information 1112 including information about the users themselves, network information 1114 including information about networks that are being maintained by the system, and system values 1116 that may be used by the networking service facility 1108 to make determinations regarding whether to connect users to networks.

While not illustrated in FIG. 11, a computing device may additionally have one or more components and peripherals, including input and output devices. These devices can be used, among other things, to present a user interface. Examples of output devices that can be used to provide a user interface include printers or display screens for visual presentation of output and speakers or other sound generating devices for audible presentation of output. Examples of input devices that can be used for a user interface include keyboards, and pointing devices, such as mice, touch pads, and digitizing tablets. As another example, a computing device may receive input information through speech recognition or in other audible format.

FIG. 12 illustrates one exemplary computer system in which a computing device, such as computing device 1100 of FIG. 11, may operate. The computer system 1200 of FIG. 12 may include user devices 1202, including user devices 1202A, 1202B, and 1202C. Each of the user devices may be associated with a user and may permit the user to interact with a networking service, such as permitting a user to communicate with other users using the networking service and to join behavior-based networks managed by the networking service. The user devices 1202 may therefore enable users to provide or may (when configured by a user to do so) automatically provide behavior information to the networking service. Any suitable computing device may be used as a user device in the computer system 1200. As shown in FIG. 12, exemplary devices include smart phone 1202A, personal digital assistant 1202B, and personal computer 1202C, but other devices possible.

The computer system 1200 also includes one or more servers 1204 that host and operate a networking system. The one or more servers 1204 may be implemented as the computing device 1100 of FIG. 11 or in any other suitable manner. The networking service of the servers 1204 may receive behavior information from users, compare the behavior information, connect users engaged in similar behaviors in networks, and disconnect users from networks based on changes in behavior. The networking service of servers 1204 may also receive and route communications between users of the networking service, such as by receiving communication data from user devices 1202. Servers 1204 may store information relating to the networking service—including information about users of the networking service and networks managed by the networking service—in a data store 1204A.

The user devices 1202 and the servers 1204 may be communicatively coupled by any suitable communication network 1206. Communication network 1206 may include any suitable wired and/or wireless communication media/medium, and may include any combination of one or more local or wide area networks, as well as any other type of network. In some embodiments, the communication network 1206 may include the Internet.

Embodiments have been described where the techniques are implemented in circuitry and/or computer-executable instructions. It should be appreciated that some embodiments may be in the form of a method, of which at least one example has been provided. The acts performed as part of the method may be ordered in any suitable way. Accordingly, embodiments may be constructed in which acts are performed in an order different than illustrated, which may include performing some acts simultaneously, even though shown as sequential acts in illustrative embodiments.

Various aspects of the embodiments described above may be used alone, in combination, or in a variety of arrangements not specifically discussed in the embodiments described in the foregoing and is therefore not limited in its application to the details and arrangement of components set forth in the foregoing description or illustrated in the drawings. For example, aspects described in one embodiment may be combined in any manner with aspects described in other embodiments.

Use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” “having,” “containing,” “involving,” and variations thereof herein, is meant to encompass the items listed thereafter and equivalents thereof as well as additional items.

Having thus described several aspects of at least one embodiment, it is to be appreciated that various alterations, modifications, and improvements will readily occur to those skilled in the art. Such alterations, modifications, and improvements are intended to be part of this disclosure, and are intended to be within the spirit and scope of the principles described herein. Accordingly, the foregoing description and drawings are by way of example only.

1. For use in a networking service having a plurality of users, a method for determining whether to connect users in a network, the method comprising:
operating at least one programmed processor to carry out a series of acts, the series of acts being identified by executable instructions with which the at least one programmed processor is programmed, the series of acts comprising:
comparing at least one behavior property of a behavior of a first user to at least one behavior property of a behavior of a second user to determine whether there are matches in behavior properties; and
calculating, based on the comparing, a match value indicating a similarity of the behavior of the first user to the behavior of the second user; and
when the match value exceeds a threshold, connecting the first user to the second user in a network of the networking service.

2. The method of claim 1, wherein the series of acts further comprises:
receiving as input, from a computing device operated by the first user, information indicating the behavior of the first user; and
determining the at least one behavior property based at least in part on the information.

3. The method of claim 2, wherein receiving information indicating the behavior of the first user comprises receiving information describing an activity in which the first user is or will be engaged.

4. The method of claim 1, wherein calculating the match value comprises:
for each behavior property determined to be a match in the comparing, identifying a property match value for the behavior property based at least in part on a weighting factor corresponding to the behavior property;
calculating the match value based at least in part on the property match values.

5. The method of claim 4, wherein the series of acts further comprises:
assigning an initial value to a property weighting factor corresponding to a particular behavior property; and
changing a value of the property weighting factor based on conditions of the networking service.

6. The method of claim 5, wherein changing the value of the property weighting factor based on conditions of the networking service comprises:
when the particular behavior property is determined to be a match and users are connected in a network based on the particular behavior property, determining a level of interaction between the users in the network; and
changing the value of the property weighting factor based on the level of interaction between the users in the network.

7. The method of claim 5, wherein changing the value of the property weighting factor based on conditions of the networking service comprises:
when the particular behavior property is determined to be a match and the first user is connected to at least one other user in a network based on the particular behavior property, determining a level of interaction of the first user with the network; and
changing the value of the property weighting factor based on the level of interaction of the first user with the network.

8. The method of claim 5, wherein changing the value of the property weighting factor based on conditions of the networking service comprises:
changing the value of the property weighting factor based at least in part on input from the first user relating to the property weighting factor.

9. The method of claim 1, wherein the second user is connected to at least one third user in the network prior to the comparing, the second user and the at least one third user having at least one matched behavior property, and
wherein comparing the at least one behavior property of the first user to the at least one behavior property of the second user comprises comparing the at least one behavior property of the first user to the at least one matched behavior property.

10. The method of claim 1, wherein the series of acts further comprises:
detecting a change in the at least one behavior property of the first user;
calculating a new match value indicating whether the first user and the second user should remain connected following the change; and
when the new overall match value is below a second threshold, disconnecting the first user from the second user.

11. At least one computer-readable storage medium encoded with computer-executable instructions that, when executed by at least one computer, cause the at least one computer to carry out a method for determining whether to connect users in a social network, the method comprising:
receiving, from a computing device operated by the first user, first information indicating an offline behavior a first user in which the user is or will be engaged;
comparing at least one behavior property of the offline behavior of the first user to at least one behavior property of an offline behavior of a second user to determine whether there are matches in behavior properties;
for each behavior property determined to be a match in the comparing, identifying a property match value for the behavior property based at least in part on a property weighting factor corresponding to the behavior property,
calculating a match value, the match value indicating a similarity of the offline behavior of the first user to the offline behavior of the second user;
when the overall match value exceeds a threshold, connecting the first user to the second user in a social network; and
in response to receiving second information indicating that the first user has stopped engaging in the offline behavior, disconnecting the first user from the second user.

12. The at least one computer-readable storage medium of claim 11, wherein the second user is connected to at least one third user in the social network prior to the receiving the first information, the second user and the at least one third user having at least one matched behavior property, and
wherein comparing the at least one behavior property of the first user to the at least one behavior property of the second user comprises comparing the at least one behavior property of the first user to the at least one matched behavior property.

13. The at least one computer-readable storage medium of claim 12, wherein the method further comprises:
in response to receiving the second information indicating that the first user has stopped engaging in the offline behavior, disconnecting the second user from the at least one third user and eliminating the social network.

14. The at least one computer-readable storage medium of claim 11, wherein identifying the property match value comprises identifying the property match value on the weighting factor corresponding to the behavior property and on a value indicating a strength of the match between the behavior property of the first user and the behavior property of the second user.

15. The at least one computer-readable storage medium of claim 14, wherein the method further comprises:
assigning an initial value to a property weighting factor corresponding to a particular behavior property;
when the particular behavior property is determined to be a match and users are connected in a social network based on the particular behavior property, determining a level of interaction between the users in the social network; and
changing a value of the property weighting factor based on the level of interaction between the users in the social network.

16. An apparatus comprising:
at least one processor programmed to
compare at least one behavior property of a behavior of a first user to at least one behavior property of a behavior of a second user to determine whether there are matches in behavior properties,
calculate a match value indicating a similarity of the behavior of the first user to the behavior of the second user, and
when the match value exceeds a threshold, connect the first user to the second user in a network.

17. The apparatus of claim 16, wherein the at least one processor is programmed to calculate the match value at least in part by:
for each behavior property determined to be a match in the comparing, identifying a property match value for the behavior property based at least in part on a weighting factor corresponding to the behavior property;
calculating the match value based at least in part on the property match values.

18. The apparatus of claim 16, wherein the at least one processor is programmed to compare the at least one behavior property of the first user to the at least one behavior property of the second user at least in part by:
determining whether a behavior property of the first user is identical to a behavior property of the second user.

19. The apparatus of claim 16, wherein the at least one processor is programmed to compare the at least one behavior property of the first user to the at least one behavior property of the second user at least in part by:
determining whether a behavior property of the first user is similar to a behavior property of the second user.

20. The apparatus of claim 16, wherein the at least one processor is programmed to connect the first user to the second user in a social network.
